(19) United States
(12) Patent Application Publication
(10) Pub. No.: US 2016/0133425 A1
(43) Pub. Date: May 12, 2016

(54) Method and Apparatus for Recycling

(71) Applicant: Electrical Waste Recycling Group Limited, Windlestone County Durham (GB)

(72) Inventors: Shaun Donaghey, Durham (GB); Tom Meney, Durham (GB)

(73) Assignee: Electrical Waste Recycling Group Limited, Windlestone County Durham (GB)

(21) Appl. No.: 14/442,385

(22) PCT Filed: Sep. 18, 2013
(86) PCT No.: PCT/GB2013/052434

§ 371 Date: May 12, 2015

(30) Foreign Application Priority Data
Nov. 13, 2012 (GB) 1220408.7

(51) Int. Cl. H01J 9/52; B02C 23/14; B02C 18/16; B03B 9/06; B03C 1/00

(52) U.S. Cl. CPC H01J 9/52; B03B 9/062; B03C 1/00; B02C 18/16; B02C 23/14

(57) ABSTRACT

A recycling plant and method is disclosed for safely recycling flat panel displays comprising mercury. The plant comprises a size reducing means for reducing the displays into fragments, separation means for automatically separating the fragments into different material outfeed categories and a local extraction ventilation system comprising a mercury abatement system. The method comprises shredding the displays into fragments, automatically separating the fragments into different material categories, and extracting local exhaust ventilation from the plant through a mercury abatement system.

The present invention relates to a method and apparatus for recycling, and more particularly to a method and apparatus for recycling displays comprising mercury.

The global Waste Electrical and Electronic Equipment (WEEE) sector is currently transitioning from recycling mainly displays containing cathode ray tubes (CRTs), to dealing with an increasing number of flat panel displays, the majority of which are liquid crystal display panels in which the backlights contain mercury. For example, the applicant expects there to be in excess of 10 million flat panel displays entering the UK WEEE sector each year. The WEEE sector has previously employed a mix of manual and automated mechanical dismantling of CRT displays. Although CRT based displays are typically reasonably straightforward to dismantle, the degree of manual intervention has meant a sustained high cost of compliance for producers of such displays (under the Producer Compliance Scheme).

The construction of flat panel displays, by contrast to CRTs, is not well suited to manual dismantling, because, in addition to their more complicated, compact and robust assembly designs, the majority contain a plurality of small, fragile, glass backlights that include mercury. The existing automatic techniques used in dismantling CRT displays are not feasible for such displays. The UK Environment Agency's Guidance on Best Available Treatment Recovery and Recycling Techniques (BATRRT) instead calls for a laborious process involving significant manual dexterity and skill from the operator, and a combination of hand tools to safely expose and remove intact mercury bearing backlights. The backlights are conventionally recycled using a specialised lamp recycling process that can deal with the mercury.

The applicant has found that it takes a skilled operator around 15 minutes to remove the backlights and their associated systems from a flat panel display. This compares to an average disassembly process for a CRT display of around 2.5 minutes. This increase in labour cost has the potential to significantly increase compliance costs to the obligated producer.

Furthermore, the applicant has found that breakages of mercury containing lamps during their removal are frequent and may be as high as 30% under full volume manual processing conditions, even following best practices with skilled operators. Such breakages result in the release of mercury vapour. Such mercury vapour is both an environmental and health and safety hazard both during dismantling of the display and in onward transit of the lamps.

In order to try to avoid such breakages, there is a tendency for the dismantler to remove the backlight complete with end connections, clips, wiring and metal shrouds. Although this may speed up dismantling and reduce the number of lamp breakages, lamp recycling processes cannot deal with the degree of mixed materials presented as a result of such practices. A further manual dismantling process in a controlled environment appropriate for devices contaminated with mercury would be required to make such mixed materials acceptable for a typical lamp recycling process.

It is an object of the present invention to ameliorate at least some of the foregoing problems.

According to a first aspect of the invention, there is provided a recycling plant for safely recycling flat panel displays comprising mercury, comprising: a size reducing means for reducing the displays into fragments; separation means for automatically separating the fragments into different material outfeed categories; and a local exhaust ventilation extraction system for at least the size reducing means, wherein the local exhaust ventilation system comprises a mercury abatement system.

The size reducing means may comprise a shredder.

The plant may further comprise a pulveriser for further reducing the size of brittle fragments.

The plant may further comprise a static dissipation means, for the dissipation of electrostatic charge on non-conductive fragments.

The separation means may comprise a trommel screen for separating pulverised brittle fragments into a brittle material outfeed category.

The trommel screen may comprise first and second screens, wherein the apertures of the first screen are a first size, and the apertures of the second screen are a second size that is larger than the first size, and the first and second trommel screen separate the pulverised brittle fragments into two respective outfeed categories.

The first size may be approximately 5 mm and the second size may be approximately 10 mm.

The separation means may comprise a first vibrating conveyor and a first magnet, for separating ferrous material fragments into a ferrous material outfeed category.

The separation means may comprise a second vibrating conveyor and a second magnet, for separating further ferrous material fragments, thereby improving ferrous material separation.

The first and/or second magnet may be permanent overband magnets, positioned respectively above the first and/or second vibrating conveyor.

The static dissipation means may comprise an ion discharge bar positioned adjacent to the first overband magnet.

The separation means may comprise an eddy current separator, for separating material fragments based on their response to a varying magnetic field.

The static dissipation means may comprise an ion discharge bar positioned adjacent to the eddy current separator, for dissipating charge on fragments infed to the eddy current separator.

A head magnet may be provided adjacent to the eddy current separator, for removing ferrous material fragments from material infed to the eddy current separator.

The eddy current separator may be configured to separate material fragments into outfeed categories comprising: non-ferrous conducting materials and non-conducting materials.

The non-ferrous conducting outfeed category may be further sub-divided into categories comprising: highly conductive materials including fragments consisting of aluminium, and less conductive materials including circuit board fragments consisting of a mix of conducting and non-conducting materials.

The separation means may comprise an air uplift separator for removing fine dust particles to form a dust and particle outfeed.

The local exhaust ventilation system may comprise a bag filter for separating fine dust particles from an air stream extracted from the plant.

The local exhaust ventilation system may further comprise a HEPA filter for extracting very small particles from the air stream extracted from the plant.

The HEPA filter may comprise a cellulose fibre cartridge filter.

The mercury abatement system may comprise sulphur impregnated carbon for adsorbing mercury vapour.

Each element of the plant may be enclosed so that air and vapour is substantially prevented from escaping the plant except via the local exhaust ventilation system.

The local exhaust ventilation system may exhaust into a building in which the plant is housed.

According to a second aspect of the invention, there is provided a recycling apparatus comprising a plant according to the first aspect of the invention, further comprising an ambient air mercury abatement system for removing mercury from the air within a building in which the plant is housed.

According to a third aspect of the invention, there is provided a method for safely recycling flat panel displays comprising mercury by processing the displays in an automatic recycling plant, the method comprising: shredding the displays into fragments, automatically separating the fragments into different material categories, and extracting local exhaust ventilation from the plant through a mercury abatement system.

The method according the third aspect of the invention may be performed using the recycling plant or apparatus of the first or second aspect respectively.

Embodiments of the invention will now be described, by way of example, with reference to the accompanying drawings, in which:

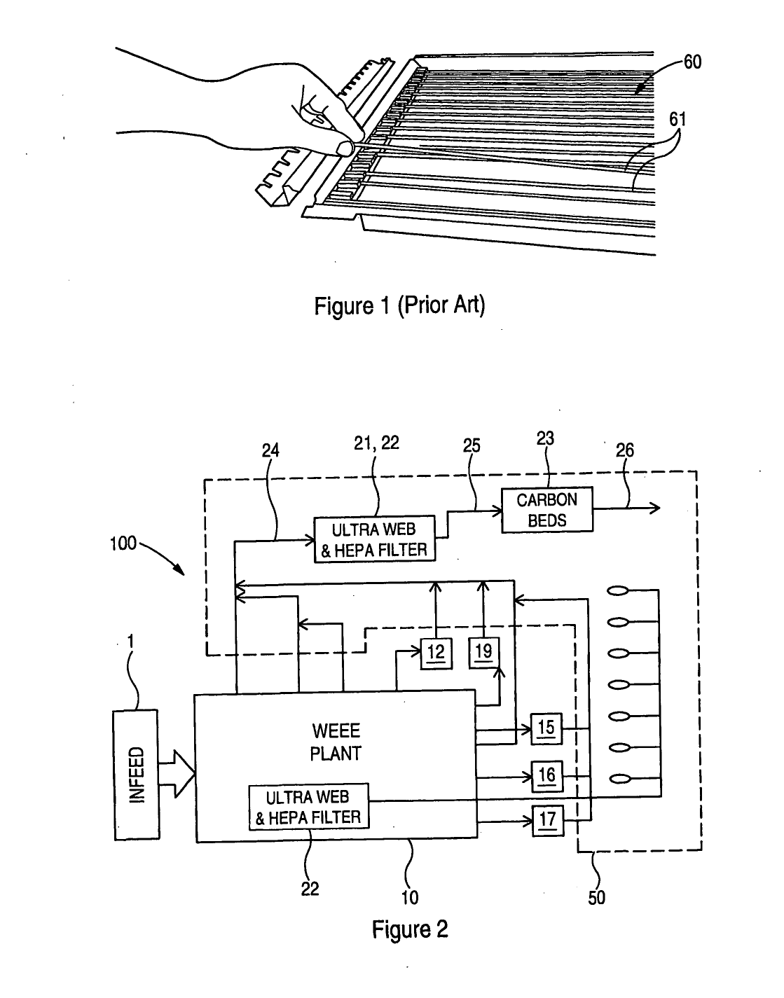

FIG. 1 is a photograph of a typical flat panel display with a backlight comprising a plurality of lamps, wherein each of the lamps contains mercury;

FIG. 2 is a schematic diagram of an recycling plant according to an embodiment of the invention; and

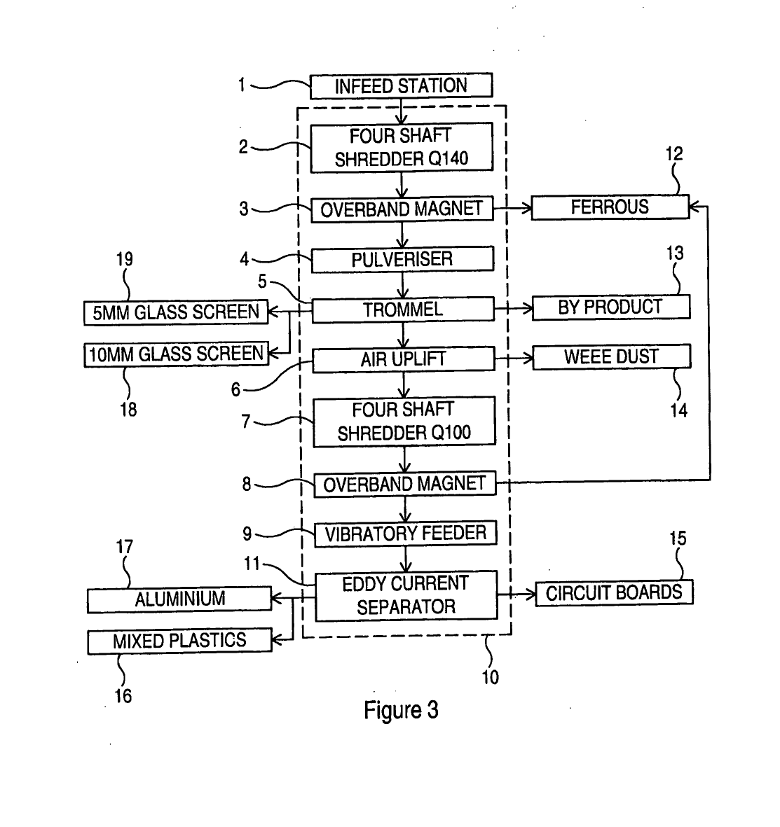

FIG. 3 is a flow diagram of a recycling process according to an embodiment of the invention.

FIG. 1 shows a typical flat panel display 60 with a plurality of cold cathode fluorescent backlight lamps 61. In order to access the lamps 61, the display 60 must be carefully dismantled. The lamps 61 are typically long, thin and extremely fragile, as shown in FIG. 1, and are consequently prone to damage.

FIG. 2 shows a recycling plant 100 according to an embodiment of the invention, for carrying out a recycling process as shown in FIG. 3. The recycling plant comprises a WEEE recycling plant 10 that has been adapted for the automatic recycling of flat panel displays comprising mercury. The recycling plant 100 comprises an infeed station 1, a WEEE recycling plant 10, a local exhaust ventilation system 50 and outfeed stations 12 to 19. The local exhaust ventilation system 50 comprises bag filters 21, a HEPA (high efficiency particulate air) filter 22 and a mercury vapour abatement system 23 which removes mercury vapour from the exhaust air, as will be explained more fully below.

At the infeed station the WEEE, for example comprising flat panel displays, is manually loaded into the plant by a process operator. The WEEE is moved into the WEEE recycling plant 10 by an inclined conveyer that transports items to the initial processing stage. The infeed station may for example be loaded with flat panel displays at a rate of 2 to 3 per minute, thereby maintaining a recycling throughput of approximately 2 Tonnes per hour, but it will be appreciated that this may readily be increased, for instance to 10 Tonnes/hr

The WEEE recycling plant 10 comprises two shredders 2, 7 and separation stages that automatically dismantle displays input to the WEEE recycling plant 10 and separate the resulting fragments into different material categories.

FIG. 3 illustrates the elements of the WEEE recycling plant, and the process carried out therein.

At the top of the inclined conveyor of the infeed station 1, the displays are dropped into a hopper, and then into the primary shredder 2. The primary shredder 2 is an four shaft Shredder, operating using two 250 hp (186 kW) motors driving the contra-rotating cutting sets, which are designed to shear through the WEEE feedstock. The main purpose of the primary shredder 2 is primary size reduction, and the combination of continuous cutting and collision of already broken parts breaks apart the feedstock into smaller and smaller fragments. A considerable amount of heat is generated during the shredding process, and any mercury liberated during this process will more readily vaporise as a result. The increased surface area caused by shredding further increases the rate of vaporisation of mercury from the feedstock.

A screen is disposed under the shredder 2, which is configured to allow fragments of less than 70 mm in size to pass through, while retaining larger fragments in the shredder 2 to continue the size reduction process.

Fragments of under 70 mm in size pass through the screen, and land on a vibrating conveyor which spreads the fragmented feedstock prior to passing it under an overband magnet 3. The overband magnet 3 may be arranged over the conveyor, and diverts ferromagnetic materials, such as metals containing iron and nickel, into one of two dedicated ferrous outfeed stations 12, via a chute. Each of the ferrous outfeed stations 12 is fitted with an overfill alarm that indicates when the station 12 is filled to capacity by means of an audible and/or visual signal.

The action of the shredder 2 may result in electrostatic charge being generated on non-conducting materials. This can be problematic, since electrostatically charged materials will subsequently tend to attract dust, which may be contaminated with mercury. In order to remove static from the fragments, an ion emitting bar (not shown) is disposed immediately after the overband magnet 3. The ion emitting bar may for instance be a pulsed DC emitter long range static control system. Contamination of the non-conducting materials by mercury laden dust is thereby avoided or reduced.

After passing the overband magnet 3, the remaining non-ferrous material exits the conveyor and is directed via an enclosed chute to an enclosed pulveriser 4. It will be appreciated that prior art automated mechanical WEEE recycling plants do not include a pulveriser because, conventionally, glass elements are typically not present or are removed from WEEE before it is introduced to an automated mechanical recycling plant. The pulveriser 3 is adapted to reduce the size of brittle materials, including glass, in the fragments outfed from the previous stages of the process, and may for instance comprise a hammer mill. Tough and/or ductile materials such as plastics and metals are largely unaffected by the action of the pulveriser 4. Pulverisation 4 results in energy being imparted to the feedstock material, and tends to raise the temperature thereof, resulting in further evaporation of mercury at this stage.

The pulveriser 4 discharges material directly into the inlet chute of the enclosed trommel screen 5. Rotary screening of the pulveriser outfeed allows the pulverised glass and other small fragments to fall through at least one mesh screen. In the present embodiment that are two screens with different sized apertures, of 5 mm and 10 mm in width, but it will be appreciated that these can be adjusted to suit the operator's needs. The majority of fragments with these small dimensions will be brittle material because the shredder 2 is configured to shred down to approximately 70 mm fragments and further size reduction via the pulveriser is necessary for material to pass through the trommel screen 5. The material passing through the two trommel screens 5 is diverted into trommel collection receptacles 18, 19 underneath the plant 10.

The applicant has found that brittle plastics materials such as high impact polystyrene (HIPS) and poly methyl methacrylate (PMMA) may be affected by the pulveriser, and be shattered into pieces small enough to pass through the trommel screen. This is undesirable, since it results in plastics material fragments in the trommel collection receptacles 18, 19, which are intended to substantially contain only glass.

In order to overcome this problem, the applicant has identified that the pulveriser may be configured to produce less size reduction or attrition. In embodiments where the pulveriser is a hammer mill, this may be achieved by measures such as the use of a shorter hammer, staggered hammers, or bypass of the hammer mill. It will be understood that this reduces the overall fines output and so minimises the volume of collected material contaminated with mercury.

Alternatively, or in addition, the trommel screen may be modified such that a single extended screen with 5 mm apertures is provided. This would tend to exclude the brittle plastics fragments, which tend to remain larger than the glass fragments.

Within the trommel screen 5 an air current 6 from below uplifts fine dust particles from the outfeed, and entrains it into the local air stream of the dedicated WEEE plant local exhaust ventilation (LEV) 50, wherein the dust is subsequently removed by a combined dust and fine particulate filtration system, as explained hereinafter.

The remaining outfeed material is transported, via enclosed conveyor, to a secondary shredder 7 for further size reduction of the remaining fragments. The secondary shredder 7 in this embodiment is a shredder that operates in the same way as the primary shredder 2. The chamber capacity of the secondary shredder 7 is somewhat smaller, and the total power of the driven motors is reduced to approximately 224 kW. The screen under the secondary shredder 7 has smaller apertures of around 40 mm, and retains the material within the shredder until they reach less than this size. Once the material fragments are reduced to below 40 mm in size, they pass through the secondary shredder screen, and onto a second vibrating conveyor below, which again spreads the material prior to passing it under a second overband magnet 8. The further size reduction also serves to further liberate mixed or joined non-homogenous material types to make separation downstream easier. It will be appreciated that the secondary shredding process imparts energy to the material processed thereby, tending to increase its temperature and liberate mercury vapour.

The second overband magnet 8 removes most residual ferrous materials that remain in the outfeed material, and diverts the ferrous materials to the ferrous outfeed station 12.

Having passed under the second overband magnet 8, the ferrous metal, glass and dust fragments have been substantially removed from the outfeed, and the remaining non-ferrous and plastics fractions are ready for sorting. Firstly a vibratory feeder 9 is used to evenly meter the fragments before they are introduced to the conveyor of an eddy current separator 11. A head magnet (not shown) is provided on the final in feed conveyor immediately before the eddy current separator 11 for removing any remaining ferrous fragments from the fragments. A further ion emitting bar (not shown) of the same type discussed hereinbefore is disposed immediately before the eddy current separator 11, to again remove any static charge built-up on the non-conducting fragments, which may result in dust contamination thereof.

The eddy current separator 11 creates a magnetic field around the discharge end of a moving conveyer. The magnetic field induces a current in conductive materials, with the result that a force is exerted on such materials so that their trajectory after leaving the conveyer is modified. In the present case, the eddy current separator 11 is configured to extend the trajectory of conductive materials to “shoot” them into a hopper remote from the end of eddy current separator conveyor. Highly conductive material fragments are most affected by forces induced by the eddy current separator 11, and three distinct outfeed fractions are generated by the eddy current separator: highly conducting fragments (e.g. aluminium), less conducting fragments (e.g. circuit boards comprising copper) and non-conductive fragments (e.g. mixed plastics). The non-conducting, non-ferrous material fragments are unaffected by the magnetic field, and simply drop off the conveyor into an adjacent mixed plastics outfeed station 16 via a hopper. The non-ferrous material fragments are diverted back to a point before the second overband magnet 8. The aluminium fragments are collected in the aluminium outfeed station 17, and the circuit boards at the circuit board outfeed station 15.

The WEEE plant 10 is provided with a comprehensive LEV extraction system 50, and takeoff points serve each stage of the process to provide a full plant LEV system. As the skilled person will be aware, local exhaust ventilation systems are typically used to avoid contamination of air by specific high-emission sources by capturing airborne contaminants before they are spread into the environment. In contrast to the typical open conveyors and chutes of prior art WEEE recycling plants, the WEEE plant 10 of the present embodiment is interconnected with a series of covered and sealed conveyors, with air-take off points to prevent emission of harmful vapours. In particular, the shredders are fully enclosed and extracted by the LEV system 50. The inventors believe that Hg will be present not only in vapour form, but also in elemental form attached to dust particles, phosphor powders and bound in cathode amalgams. By enclosing each stage of the process and extracting by the LEV system, Hg in each of these forms can be extracted as it liberates from these materials and/or is separated at the screening and filtering stages. This is in contrast to prior art where heat is applied during initial shredding and there is total reliance on vapour phase extraction. The extract leaving the WEEE plant via the LEV extraction system 50 is subject to a three stage filtration process.

Firstly, the particulate, solid phase substances entrained in the air stream are collected by bag filters 21. This removes the bulk of the particulate load, which is collected and forms the WEEE dust outfeed 14.

Secondly the extracted air 24 is passed through a HEPA filter 22. In the present embodiment the HEPA filter 22 comprises a cellulose fibre cartridge filter (Ultra web), combined with a further HEPA filter, and thereby removes any remaining ultra fine particles down to less than 3 μm in size.

Thirdly, the extracted, particle free air 25, is drawn through a mercury abatement system 23 comprising carbon beds. In the present embodiment, eight carbon beds are employed, each containing 1.1 tonnes of sulphur impregnated carbon that adsorbs mercury to form a mercuric sulphide bond that retains the mercury until the carbon is treated at the end of the life of carbon bed media. Following this three stage filtration process the cleaned air 26 is exhausted. The levels of particulate and mercury in the exhausted air 26 is constantly monitored to ensure that the LEV system 50 is functioning properly. In some embodiments, the cleaned air may be exhausted inside the building housing the WEEE plant 10 and LEV system 50, at an elevated level. In order to further augment the WEEE plant LEV system 50, a further ambient air extraction system serves the building (not shown). This secondary extraction system has more widely spread air takeoff points, and effectively “mops-up” any fugitive emissions from the plant LEV system 50. This secondary extraction system employs the same three stage process as the plant LEV system 50. The combination of a secondary extraction system having a mercury abatement system with the exhaust from the LEV system 50 being inside the building may be advantageous in ensuring that no mercury is emitted because any mercury in the exhaust of the plant LEV system 50 will thereby be captured by the secondary extraction system.

The present applicant has run trials with the system according to the example embodiment. 10 tonnes of flat panel displays comprising mercury were recycled at a rate of 2 tonnes/hour. It is anticipated that the system according to the example embodiment would be able to accommodate a recycling rate of 10 tonnes/hour.

A recyclable materials recovery rate of greater than 86% was measured, which is comfortably within both the 75% minimum rate presently specified by Article 7 of the WEEE Directive 2002/86/EC and the revised 80% target for 2015 set out in Annex V of the WEEE Directive Recast 2012/19/EU. Process improvements identified during the trial should make it possible to increase recovery rates to more than 95%.

Mercury contamination of outfeed materials was found to be low, with the exception of approximately 13 kg of WEEE dust deposited in the LEV system 50, which requires designation as hazardous waste. Approximately 33% of the mercury input to the process was captured by the mercury abatement system 23, and just 0.8% of the mercury input to the system was exhausted into the building environment to be captured by the secondary extraction system.

Emissions of mercury and mercury build-up within the building was found to be low, due to the efficiency of the LEV system 50 in removing mercury. Operator exposure to mercury was low, and very low for cadmium and lead. The single highest mercury exposure measurement was 50% of the UK workplace exposure limit (WEL), and for lead and cadmium was less than 10% of the respective UK WELs.

Swabs of the internal galvanised surfaces of the ductwork of the LEV system 50 suggest that only trace amounts of mercury were retained thereon.

The trial therefore indicated that a process according to an embodiment of the invention is a viable and competitive alternative to the present manual dismantling process. A WEEE plant according to an embodiment allows cost effective automated mechanical processing of flat panel displays comprising mercury without detrimental effects on the environment, without increased risk to operators and without the risk of cross contamination generating significant quantities of additional hazardous waste. The process deals with the main hazardous constituent (mercury) of flat panel displays in-situ within the primary process with an overall recovery rate that exceeds present and future legislative requirements, combined with a vastly improved process throughput rate. The process can therefore be used to address the rapid increase in demand for flat panel display WEEE recycling as the sector transitions from CRT based displays for FPD display technology.

Although the description of the example embodiment has focused on flat panel display screens, it will be appreciated that the present invention is applicable to other types of WEEE.

Although specific example embodiments have been disclosed, it will be appreciated that various modifications are possible, within the scope of the invention, as defined by the appended claims.

1. A recycling plant for safely recycling flat panel displays comprising mercury, comprising:
a size reducer configured to reduce the displays into fragments;
a separator configured to automatically separate the fragments into different material outfeed categories; and
a local exhaust ventilation extraction system for at least the size reducer, wherein the local exhaust ventilation system comprises a mercury abatement system.

2. The plant according to claim 1, wherein the size reducer comprises a shredder.

3. The plant according to claim 1, further comprising a pulveriser for further reducing the size of brittle fragments.

4. The plant according to claim 1, further comprising a static dissipation device configured to dissipate electrostatic charge on non-conductive fragments.

5. The plant according to claim 3, wherein the separator comprises a trommel screen for separating pulverised brittle fragments into a brittle material outfeed category.

6. The plant according to claim 5, wherein the trommel screen comprises first and second screens, wherein the apertures of the first screen are a first size, and the apertures of the second screen are a second size that is smaller than the first size, and the first and second trommel screen separate the pulverised brittle fragments into two respective outfeed categories.

7. (canceled)

8. The plant according to claim 1, wherein the separator comprises a first vibrating conveyor and a first magnet, for separating ferrous material fragments into a ferrous material outfeed category.

9. The plant according to claim 8, wherein the separator comprises a second vibrating conveyor and a second magnet, for separating further ferrous material fragments, thereby improving ferrous material separation.

10. The plant according to claim 8, wherein the first and/or second magnet are permanent overband magnets, positioned respectively above the first and/or second vibrating conveyor.

11. (canceled)

12. The plant according to claim 1, wherein the separator comprises an eddy current separator, for separating material fragments based on their response to a varying magnetic field.

13. (canceled)

14. The plant according to claim 12, wherein a head magnet is provided adjacent to the eddy current separator, for removing ferrous material fragments from material infed to the eddy current separator.

15. The plant according to claim 12, wherein the eddy current separator may be configured to separate material fragments into outfeed categories comprising: non-ferrous conducting materials and non-conducting materials.

16. The plant according to claim 15, wherein the non-ferrous conducting outfeed category is further sub-divided into categories comprising: highly conductive materials including fragments consisting of aluminium, and less conductive materials including circuit board fragments consisting of a mix of conducting and non-conducting materials.

17. The plant according to claim 1, wherein the separator comprises an air uplift separator for removing fine dust particles to form a dust and particle outfeed.

18. The plant according to claim 1, wherein the local exhaust ventilation system comprises a bag filter for separating fine dust particles from an air stream extracted from the plant.

19. The plant according to claim 18, wherein the local exhaust ventilation system further comprises a HEPA filter for extracting very small particles from the air stream extracted from the plant.

20. The plant according to claim 19, wherein the HEPA filter comprises a cellulose fibre cartridge filter.

21. The plant according to claim 1, wherein the mercury abatement system comprises sulphur impregnated carbon for adsorbing mercury vapour.

22. The plant according to claim 1, wherein the separator is enclosed and connected to the local exhaust ventilation system so that air and vapour is substantially prevented from escaping the plant except via the local exhaust ventilation system.

23. A plant according to claim 1, wherein each element of the plant is enclosed and connected to the local exhaust ventilation system so that air and vapour is substantially prevented from escaping the plant except via the local exhaust ventilation system.

24. A plant according to claim 1, additionally comprising a building which houses the other elements of the plant and into which the local exhaust ventilation system exhausts.

25. A plant according to claim 24, wherein the building is provided with an ambient air mercury abatement system for removing mercury from the air within the building.

26. A method for safely recycling flat panel displays comprising mercury by processing the displays in an automatic recycling plant, the method comprising: shredding the displays into fragments, automatically separating the fragments into different material categories, and extracting local exhaust ventilation from the plant through a mercury abatement system.

27. The method of claim 26, performed using a recycling plant for safely recycling flat panel displays comprising mercury, comprising:
a size reducer configured to reduce the displays into fragments;
a separator configured to automatically separate the fragments into different material outfeed categories; and
a local exhaust ventilation extraction system for at least the size reducer, wherein the local exhaust ventilation system comprises a mercury abatement system.
